(19) United States
(12) Patent Application Publication
(10) Pub. No.: US 2022/0069279 A1
(43) Pub. Date: Mar. 3, 2022

(54) ALL-SOLID-STATE BATTERY AND MANUFACTURING METHOD THEREFOR

(71) Applicant: RESEARCH INSTITUTE OF INDUSTRIAL SCIENCE & TECHNOLOGY, Pohang-si (KR)

(72) Inventors: Sang Cheol NAM, Seoul (KR); Ji Woong MOON, Pohang-si (KR); Jung Hoon SONG, Seoul (KR)

(21) Appl. No.: 17/415,078

(22) PCT Filed: Dec. 6, 2019
(86) PCT No.: PCT/KR2019/017220

§ 371 Date: Jun. 17, 2021

(30) Foreign Application Priority Data
Dec. 19, 2018 (KR) 10-2018-0165647

(51) Int. Cl. H01M 4/131; H01M 4/134; H01M 4/505; H01M 4/525; H01M 4/38; H01M 4/1391; H01M 4/04; H01M 10/0525; H01M 10/0562; H01M 10/0585

(52) U.S. Cl. CPC H01M 4/131; H01M 4/134; H01M 4/505; H01M 4/525; H01M 4/382; H01M 2300/0071; H01M 4/0404; H01M 4/0414; H01M 10/0525; H01M 10/0562; H01M 10/0585; H01M 4/1391

(57) ABSTRACT

The present invention relates to an all-solid-state battery and a manufacturing method thereof.

An all-solid-state battery according to an embodiment of the present invention includes: a positive electrode positioned on a positive electrode current collector; a negative electrode positioned on a negative electrode current collector; and a solid-state electrolyte layer positioned between the positive electrode and the negative electrode, wherein the positive electrode includes a positive electrode active material and a solid-state electrolyte, and concentrations of the positive electrode active material and the solid-state electrolyte have a stepwise concentration gradient in which the concentration of the positive electrode active material to the solid-state electrolyte decreases from a side closer to the positive electrode current collector toward a side closer to the solid-state electrolyte layer.

### TECHNICAL FIELD

The present invention relates to an all-solid-state battery and a manufacturing method thereof. More specifically, the present invention relates to an all-solid-state battery in which a positive electrode has a stepwise concentration gradient, and a manufacturing method thereof.

### BACKGROUND ART

As the era of wireless mobile matures, the importance of power supply is increasing more than ever. Particularly, lithium-ion batteries are used in most electronic devices because their energy density per volume is far higher than that of other battery systems, and are expanding their application range to automobiles and energy storage devices in addition to applications for small devices. However, since the existing lithium-ion battery basically uses a liquid electrolyte, safety problems of explosion and ignition continue to occur, and thus, a lot of researches are being conducted to solve this problem, and for example, research to improve safety such as ceramic coating of a separator and flame-retardant electrolyte containing additives is being actively conducted, but there is no way to fundamentally solve the aforementioned problems. Generally, in a case of a lithium-ion battery using an oxide-based cathode active material, when a battery temperature rises instantaneously, such as when a cathode is overcharged or a battery is short-circuited, as the cathode active material is decomposed, oxygen is generated, and at this time, an organic solvent used as an electrolyte ignites, causing swelling, explosion, or fire. There were 17 or more reports of such safety accidents from 2004 to 2011, and in recent years, even battery packs installed inside an electric vehicle and aircraft have caused fires, thus safety issues are increasing more than ever. For these safety issues, as capacity of lithium-ion batteries becomes medium and large in the future, it is necessary to prepare fundamental measures to secure stability.

Among methods to solve this problem, one of most popular methods in recent years is to change an organic electrolyte corresponding to a fuel into a solid-state electrolyte so that explosion/ignition may fundamentally not occur. When the solid-state electrolyte is used, 1) safety problems may be solved by blocking a fundamental cause of explosion/ignition, and 2) as a potential window is wide, it is possible to reuse a high voltage cathode of 4.5 V or higher, and to use metallic lithium as an anode material, so that is is possible to theoretically increase an energy density by 2 to 3 times compared with the current lithium-ion battery. 3) In addition, since the current LiB degassing process may be omitted in the manufacturing process thereof, a process yield may be improved, and costs may be reduced through simplification.

All-solid-state batteries may be largely classified into oxide-based batteries and sulfide-based batteries depending on a type of solid-state electrolyte used, and the oxide-based batteries may be classified into thin film type of batteries and bulk type of batteries depending on a manufacturing process thereof. The oxide-based all-solid-state battery, due to issues of low ionic conductivity and high interfacial resistance, are not easy to commercialize with oxide-based materials themselves, and thus, to solve this problem, a pseudo all-solid-state battery in which small amounts of oxide-based solid-state electrolyte, polymer material, and liquid electrolyte are impregnated is promising. When such an all-solid-state battery uses the positive electrode plate and negative electrode plate of the lithium ion battery using the existing liquid electrolyte as it is, and when the separator is changed to a solid-state electrolyte layer thereof, penetration of the electrolyte between the electrode plates does not matter in a case in which thicknesses of the electrode plates are thin, but in a case in which the thicknesses of the electrode plates increase, it is difficult for the electrolyte to penetrate up to a lower part of the electrode plate, making it very difficult to realize capacity of the battery. In order to solve this problem, from a time of manufacturing an electrode plate, the electrode plate is manufactured so that a solid-state electrolyte is contained, and a solid-state electrolyte layer is applied and cured on an upper part of the electrode plate to form a battery. In this case, when an amount of an active material is increased, electrode plate resistance increases and the capacity thereof excessively decreases, which is overcome by increasing a content of the solid-state electrolyte, and in this case, since about 60% of the amount of the active material is usually contained therein and the solid-state electrolyte occupies the remaining part thereof, compared with the conventional lithium ion battery, capacity thereof per unit area is greatly reduced, and the manufacturing process thereof is also performed in a uniform composition form.

Therefore, there is a need for a method to solve the problem of high resistance generation and low capacity of the existing all-solid-state battery.

### DISCLOSURE

The present invention has been made in an effort to provide an all-solid-state battery and a manufacturing method thereof. More specifically, the present invention has been made in an effort to provide an all-solid-state battery in which a positive electrode has a stepwise concentration gradient, and a manufacturing method thereof.

An all-solid-state battery according to an embodiment of the present invention includes: a positive electrode positioned on a positive electrode current collector; a negative electrode positioned on a negative electrode current collector; and a solid-state electrolyte layer positioned between the positive electrode and the negative electrode, wherein the positive electrode contains a positive electrode active material and a solid-state electrolyte, and concentrations of the positive electrode active material and the solid-state electrolyte have a stepwise concentration gradient in which a concentration of the positive electrode active material with respect to the solid-state electrolyte decreases from a side closer to the positive electrode current collector toward a side closer to the solid-state electrolyte layer.

In the stepwise concentration gradient, the concentration of the positive electrode active material may be constantly stepwise decreased by 5 to 15 wt % from the side closer to the positive electrode current collector toward the side closer to the solid-state electrolyte layer.

In the stepwise concentration gradient, the concentration of the positive electrode active material closer to the positive electrode current collector may be 88 to 97 wt % with respect to 100 wt % of a sum of the positive electrode active material and the solid-state electrolyte.

In the stepwise concentration gradient, the concentration of the positive electrode active material closer to the solid-state electrolyte layer may be 48 to 61 wt % with respect to 100 wt % of a sum of the positive electrode active material and the solid-state electrolyte.

In the stepwise concentration gradient, intervals between sections having the same concentration may be the same.

The positive electrode (cathode) active material may be expressed as LiCoO₂, LiMn₂O₄, LiNiO₂, LiFePO₄, or LiNi_{0.5}Mn_{1.5}O₄, or by the following Chemical Formula 1.

Liₐ₁Ni_{b1}Co_{c1}Mn_{d1}M1ₑ₁M2_{f1}O_{2-f1} [Chemical Formula 1]

In Chemical Formula 1, 0.8≤a1≤1.2, 0.3≤b1≤0.95, 0.03≤c1≤0.3, 0.001≤d1≤0.3, 0≤e1≤0.05, 0≤f1≤0.02, b1+c1+d1+e1+f1=1; M1 is one selected from Na, Mg, Al, Si, K, Ca, Sc, Ti, V, B, Cr, Cu, Zn, Ga, Ge, Rb, Sr, Y, Zr, Nb, Mo, Tc, Ru, Rh, Pd, Ag, Cd, In, Sn, Ba, W, and a combination thereof; and M2 is one selected from N, F, P, S, Cl, Br, I, and a combination thereof.

The negative electrode may include one or more selected from a group consisting of natural graphite, artificial graphite, coke, hard carbon, tin oxide, silicon, lithium, lithium oxide, and a lithium alloy.

The solid-state electrolyte may contain an oxide-based solid-state electrolyte.

The oxide-based solid-state electrolyte may contain one or more selected from a group consisting of LLZO, LATP, LAGP, LLTO, LiPON, LiBON, and lithium borate.

The all-solid-state battery may be a bi-polar type of battery.

A manufacturing method of an all-solid-state battery according to an embodiment of the present invention includes: coating a plurality of mixed layers including a positive electrode active material and a solid-state electrolyte on a positive electrode current collector, wherein concentrations of the positive electrode active material and the solid-state electrolyte are different from each other; and coating a solid-state electrolyte layer on the coated plurality of mixed layers, wherein in the coating of the plurality of mixed layers, the plurality of mixed layers, from the mixed layer in which a concentration of the positive electrode active material is higher than that of the solid-state electrolyte, are sequentially coated on the positive electrode current collector to form a stepwise concentration gradient.

The coating of the plurality of mixed layers may be printing and coating a mixed solution obtained by mixing a positive electrode active material and a solid-state electrolyte dispersion, and the coating of the solid-state electrolyte layer on the plurality of coated mixed layers may be printing and coating the solid-state electrolyte dispersion.

The coating of the plurality of mixed layers and the coating of the solid-state electrolyte layer on the plurality of coated mixed layers may be performed by using a screen printing method.

In the coating of the plurality of mixed layers, in the stepwise concentration gradient, the concentration of the positive electrode active material may be constantly varied in steps by 5 to 15 wt %.

The solid-state electrolyte dispersion may include an electrolyte solution, an oxide-based solid-state electrolyte powder, and a polymer matrix.

The oxide-based solid-state electrolyte powder may contain one or more selected from a group consisting of LLZO, LATP, LAGP, LLTO, LiPON, LiBON, and lithium borate.

The all-solid-state battery according to an embodiment of the present invention may greatly improve the high resistance and low capacity expression rate in the existing all-solid-state battery structure.

### DESCRIPTION OF THE DRAWINGS

FIG. 1 illustrates a photograph of a surface morphology of a solid-state electrolyte according to an embodiment of the present invention.

FIG. 2 illustrates a Nyquist plot for measuring ion conductivity of a solid-state electrolyte according to an embodiment of the present invention.

FIG. 3 illustrates a schematic view of a cathode (positive electrode) coating method according to an embodiment of the present invention.

FIG. 4 illustrates a graph of a concentration gradient profile according to a thickness of a cathode according to an embodiment of the present invention.

FIG. 5 illustrates a schematic configuration view of a single cell of an all-solid-state battery according to an embodiment of the present invention.

FIG. 6 illustrates a schematic configuration view of a bi-polar type of cell of an all-solid-state battery according to an embodiment of the present invention.

FIG. 7 illustrates a graph of concentration profiles of cathodes according to Example 1 of the present invention, Comparative Example 1, and Comparative Example 2.

FIG. 8 illustrates charging and discharging curves according to cathode concentration gradients according to Example 1, Comparative Example 1, and Comparative Example 2.

FIG. 9 illustrates Nyquist plots of electrodes of Example 1, Comparative Example 1, and Comparative Example 2 measured by using an AC impedance measurement method.

### MODE FOR INVENTION

In the present specification, it will be understood that, although the terms first, second, third, etc. may be used herein to describe various elements, components, regions, areas, layers, and/or sections, they are not limited thereto. These terms are only used to distinguish one element, component, region, layer, or section from another element, component, region, layer, or section. Therefore, a first part, component, area, layer, or section to be described below may be referred to as second part, component, area, layer, or section within the range of the present invention.

In the present specification, in order to clearly describe the present invention, parts that are irrelevant to the description are omitted, and identical or similar constituent elements throughout the specification are denoted by the same reference numerals.

In the present specification, unless explicitly described to the contrary, the word “comprise” and variations such as “comprises” or “comprising” will be understood to imply the inclusion of stated elements but not the exclusion of any other elements.

The technical terms used herein are to simply mention a particular embodiment and are not meant to limit the present invention. The terminologies used herein are just to illustrate a specific embodiment, but are not intended to limit the present invention. In the specification, it is to be understood that the terms such as “including”, “having”, etc., are intended to indicate the existence of specific features, regions, numbers, stages, operations, elements, components, and/or combinations thereof disclosed in the specification, and are not intended to preclude the possibility that one or more other features, regions, numbers, stages, operations, elements, components, and/or combinations thereof may exist or may be added.

In the present specification, the term “combination of these” included in the expression of a Markush form means one or more mixtures or combinations selected from a group consisting of configuration components described in the Markush form representation, and it means to include one or more selected from the group consisting of the configuration components.

In the present specification, when referring to a part as being “on” or “above” another part, it may be positioned directly on or above another part, or another part may be interposed therebetween. In contrast, when referring to a part being “directly above” another part, no other part is interposed therebetween.

Unless otherwise defined, all terms used herein, including technical or scientific terms, have the same meanings as those generally understood by those with ordinary knowledge in the field of art to which the present invention belongs. Terms defined in commonly used dictionaries are further interpreted as having meanings consistent with the relevant technical literature and the present disclosure, and are not to be construed as having idealized or very formal meanings unless defined otherwise.

Unless otherwise stated, % means % by weight, and 1 ppm is 0.0001% by weight.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

Advantages and features of the present invention and methods of accomplishing the same may be understood more readily by reference to the following detailed description of preferred embodiments and the accompanying drawings. However, the present invention is not limited to the embodiments described hereinafter, and may be embodied in many different forms. The following embodiments are provided to make the disclosure of the present invention complete and to allow those skilled in the art to clearly understand the scope of the present invention, and the present invention is defined only by the scope of the appended claims. Throughout the specification, the same reference numerals denote the same constituent elements.

In some embodiments, detailed description of well-known technologies will be omitted to prevent the disclosure of the present invention from being interpreted ambiguously. Unless otherwise defined, all terms (including technical and scientific terms) used herein have the same meaning as commonly understood by one of ordinary skill in the art.

First, in a case of an all-solid-state battery including a solid-state electrolyte as well as a cathode active material in the existing cathode, when an amount of the active material is increased, electrode plate resistance increases and the capacity thereof excessively decreases, which is overcome by increasing a content of the solid-state electrolyte, and in this case, since about 60% of the amount of the active material is usually contained therein and the solid-state electrolyte occupies the remaining part thereof, compared with the conventional lithium ion battery, capacity thereof per unit area is greatly reduced. Therefore, unlike a conventional positive electrode plate manufacturing method having a positive electrode (cathode) active material/solid-state electrolyte in a certain composition, an embodiment of the present invention provides an all-solid-state battery structure having a stepwise concentration gradient in which an amount of an active material of an electrode plate portion is increased near a current collector and is decreased in an area meeting the electrolyte, so that it solves the problem of high resistance generation and low capacity of the existing all-solid-state battery.

An all-solid-state battery according to an embodiment of the present invention includes: a positive electrode (cathode) positioned on a positive electrode current collector; a negative electrode (anode) positioned on a negative electrode current collector; and a solid-state electrolyte layer positioned between the positive electrode and the negative electrode, wherein the positive electrode includes a positive electrode active material and a solid-state electrolyte, and concentrations of the positive electrode active material and the solid-state electrolyte have a stepwise concentration gradient in which the concentration of the positive electrode active material to the solid-state electrolyte decreases from a side closer to the positive electrode current collector toward a side closer to the solid-state electrolyte layer.

When the positive electrode having the concentration gradient is used for the all-solid-state battery, mobility and electrical conductivity of lithium ions are improved compared with the conventional all-solid-state battery using a positive electrode having a constant composition, so that the performance of the all-solid-state battery may be improved. This may maximize its effect, particularly in a pseudo all-solid-state battery containing a very small amount of liquid electrolyte. The reason is that the positive electrode active material near the current collector has more resistance than the positive electrode active material near the electrolyte.

The all-solid-state battery for which the positive electrode having the stepwise concentration gradient is used has higher initial discharge capacity, less initial IR drop, and more excellent initial efficiency than a conventional all-solid-state battery using a positive electrode having a constant composition or a positive electrode having a continuous composition.

More specifically, in the stepwise concentration gradient, the concentration of the positive electrode active material may be constantly stepwise decreased by 5 to 15 wt % from the side closer to the positive electrode current collector toward the side closer to the solid-state electrolyte layer. More specifically, it may be constantly stepwise decreased by 7 to 13 wt %. When the stepwise decrease ratio is too small, there is a disadvantage that a concentration gradient effect may not be obtained even if it is coated several times in a stepwise manner due to a particle size of the positive electrode material, and conversely, when it is too large, a difference in concentration gradient considerable occurs, so that an amount of the solid-state electrolyte positioned close to the electrolyte portion may be considerably increased large to largely increase resistance.

In addition, in the stepwise concentration gradient, the concentration of the positive electrode active material closer to the positive electrode current collector may be 88 to 97 wt % with respect to 100 wt % of a sum of the positive electrode active material and the solid-state electrolyte. More specifically, it may be 90 to 96 wt %.

In addition, in the stepwise concentration gradient, the concentration of the positive electrode active material closer to the solid-state electrolyte layer may be 48 to 61 wt % with respect to 100 wt % of a sum of the positive electrode active material and the solid-state electrolyte. More specifically, it may be 50 to 57 wt %.

In addition, in the stepwise concentration gradient, intervals between sections having the same concentration may be the same. When the intervals of the sections with the same concentration are the same, the same coating equipment and method may be used every time, so there is a merit that it reduces the process cost.

In this case, the positive electrode (cathode) active material may be expressed as LiCoO₂, LiMn₂O₄, LiNiO₂, LiFePO₄, or LiNi_{0.5}Mn_{1.5}O₄, or by the following Chemical Formula 1.

Liₐ₁Ni_{b1}Co_{c1}Mn_{d1}M1ₑ₁M2_{f1}O_{2-f1} [Chemical Formula 1]

In Chemical Formula 1, 0.8≤a1≤1.2, 0.3≤b1≤0.95, 0.03≤c1≤0.3, 0.001≤d1≤0.3, 0≤e1≤0.05, 0≤f1≤0.02, b1+c1+d1+e1+f1=1; M1 is one selected from Na, Mg, Al, Si, K, Ca, Sc, Ti, V, B, Cr, Cu, Zn, Ga, Ge, Rb, Sr, Y, Zr, Nb, Mo, Tc, Ru, Rh, Pd, Ag, Cd, In, Sn, Ba, W, and a combination thereof; and M2 is one selected from N, F, P, S, Cl, Br, I, and a combination thereof.

In addition, the negative electrode may include one or more selected from a group consisting of natural graphite, artificial graphite, coke, hard carbon, tin oxide, silicon, lithium, lithium oxide, and a lithium alloy.

In addition, the solid-state electrolyte may contain an oxide-based solid-state electrolyte. More specifically, the oxide-based solid-state electrolyte may contain one or more selected from a group consisting of LLZO, LATP, LAGP, LLTO, LiPON, LiBON, and lithium borate.

Meanwhile, the all-solid-state battery may be a bipolar type of battery.

A manufacturing method of an all-solid-state battery according to an embodiment of the present invention includes: coating a plurality of mixed layers containing a positive electrode active material and a solid-state electrolyte on a positive electrode current collector, wherein the plurality of mixed layers have a different concentration of the positive electrode active material with respect to the solid-state electrolyte; and coating a solid-state electrolyte layer on a plurality of coated mixed layers, and in the coating of the plurality of mixed layers, the plurality of mixed layers, from the mixed layer having a high concentration of the positive electrode active material with respect to the solid-state electrolyte, are sequentially coated on the positive electrode current collector, thereby forming a stepwise concentration gradient. The merit in the case of having the stepwise concentration gradient is omitted because it has been described above.

In this case, the coating of the plurality of mixed layers may be printing and coating a mixed solution obtained by mixing a positive electrode active material and a solid-state electrolyte dispersion, and the coating of the solid-state electrolyte layer on the plurality of coated mixed layers may be printing and coating the solid-state electrolyte dispersion. More specifically, the coating of the plurality of mixed layers and the coating of the solid-state electrolyte layer on the plurality of coated mixed layers may be performed by using a screen printing method.

The method of manufacturing the positive electrode plate includes aerosol and spray methods. However, the aerosol method basically requires an expensive manufacturing system including a deposition chamber using a vacuum pump, and above all things, its biggest drawback is that it is difficult to make a large area, and loss of raw materials during deposition is more than 50%, so commercialization is not easy. On the contrary, the coating method as in the embodiment of the present invention has advantages that it is economical due to a low raw material loss rate, and may be commercialized because it may be used on a large area.

On the other hand, in the coating of the plurality of mixed layers, in the stepwise concentration gradient, the concentration of the positive electrode active material may be constantly different in steps by 5 to 15 wt % of each. More specifically, it may be constantly different in steps by 7 to 13 wt % of each.

Meanwhile, the solid-state electrolyte dispersion may include an electrolyte solution, an oxide-based solid-state electrolyte powder, and a polymer matrix. More specifically, the oxide-based solid-state electrolyte powder may contain one or more selected from a group consisting of LLZO, LATP, LAGP, LLTO, LiPON, LiBON, and lithium borate.

Hereinafter, examples of the present invention will be described in more detail. However, it is necessary to note that the following examples are only intended to illustrate the present invention in more detail and are not intended to limit the scope of the present invention. This is because the scope of the present invention is determined by constituent elements described in the claims and reasonably inferred therefrom.

### EXAMPLE 1

### Manufacturing of Stepwise Concentration Gradient Type of Pseudo All-Solid-State Battery

(1) Manufacturing of Solid-State Polymer Electrolyte Dispersion Containing Oxide-Based Solid-State Electrolyte Powder

As a previous step for manufacturing a solid-state polymer dispersion, an electrolyte solution was manufactured. The electrolyte solution, which is a polar aprotic solvent, was prepared by dissolving 1 M of LiTFSI (bis(trifluoromethanesulfonyl)imide, 3N5, Sigma Aldrich) lithium salt in TEGDME (tetra ethylene glycol dimethyl ether, ≥99%, Sigma Aldrich) that has good chemical and thermal stability and has a high boiling point.

The oxide-based solid-state electrolyte powder was prepared by directly synthesizing LLZO (lithium lanthanum zirconate), and the manufacturing method thereof is as follows. A composition of LiOH.H₂O (Alfa Aesar, 99.995%), La₂O₃ (Kanto, 99.99%), ZrO₂ (Kanto, 99%), and Ta₂O₅ (Aldrich, 99%) were designed as Li_{6.65}La₃Zr_{1.65}Ta_{0.35}O₁₂, and in order to correct the volatilization of Li during high-temperature sintering later, a small amount of LiOH.H₂O was added excessively. Before mixing the powder, La₂O₃ was dried at 900° C. for 24 hours to remove all adsorbed moisture, and LiOH.H₂O was also dried at 200° C. for 6 hours to remove moisture adsorbed on a surface thereof. After mixing the heat treated LiOH.H₂O and La₂O₃, ZrO₂, zirconia balls of 3 mm+5 mm were charged into a Nalgene bottle charged with 1:1 mixed balls, and then a mixed powder and anhydrous IPA were added thereto to perform ball milling for 24 hours. A raw material mixture was dried in a drying furnace for 24 hours and baked in a sintering furnace at 900° C. for 3 hours, and in this case, a temperature increase speed was 2° C./min. This was pulverized by performing the ball-milling process for 12 hours again, and after being dried, it was sintered again at 1200° C. in an air atmosphere. This was pulverized by performing the ball-milling process for more than 12 hours to manufacture a uniform garnet-type of oxide-based solid-state electrolyte powder having a particle diameter of 2 μm or less, and in order to obtain nano-particles of 1 μm or less, an average diameter D50 of 0.4 μm was obtained by pulverizing it by using a jet mill.

Poly(ethylene glycol)diacrylate (PEGDAC), which is capable of both heat and UV curing, was used as a polymer to serve as a polymer matrix.

The three materials, LLZO, TEGDME in 1 M LiTFSI, and PEGDAC were mixed at 1.5:3:1.5 (wt %); in order to increase the dispersibility of the nano-particles, a dispersant, M1201 (Ferro, USA), was added at 1 wt %; and at this time, AIBN (2,2′-azobis(2-methyl propionitrile) 98%, Sigma Aldrich) and TAPP (tertiary-amylperoxy pivalate) were added at 3 wt % for thermal polymerization of PEGDAC, and then this was ball-milled for 24 hours to prepare a dispersion for a solid-state electrolyte.

(2) Measurement of Ion Conductivity of Solid-State Electrolyte

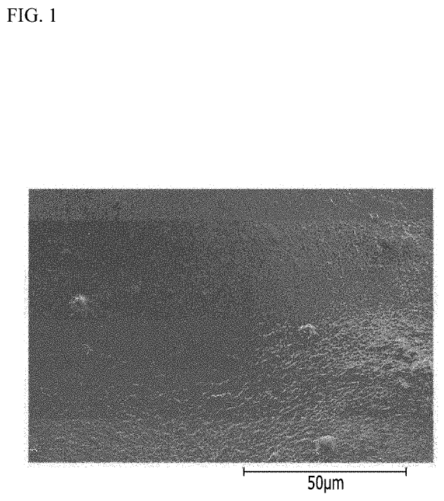

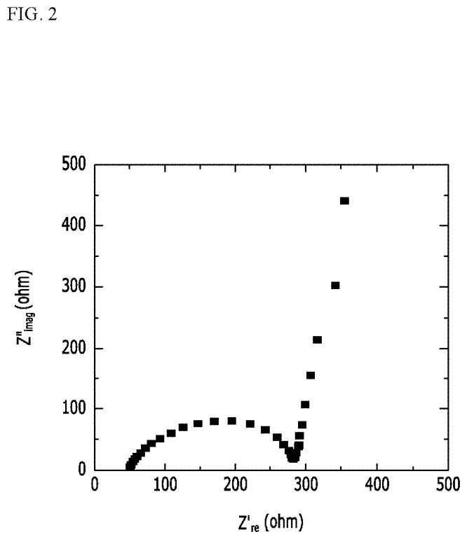

The solid-state electrolyte dispersion was uniformly coated on a polished gold substrate using a screen printing method using a 200 mesh screen, and then thermally cured at 120° C. for 3 minutes or more on a hot plate. A thickness of about 20 μm was able to be obtained when coated once by the screen printing, and this was repeated five times to form an electrolyte layer of about 100 μm. FIG. 1 shows a surface morphology of the solid-state electrolyte manufactured by the method described above, and it can be seen that it has a smooth surface even after coating, and it has excellent binding strength with a lower substrate. To measure the ion conductivity of the solid-state electrolyte, when a gold substrate of the same material with an area of 0.2 cm² is covered and thermally-pressed on an upper portion thereof, and then is scanned with an amplitude of 5 mV from 7 MHz to 0.1 Hz by using an AC impedance spectroscope, a typical semicircle was able to be obtained through a Nyquist plot as shown in FIG. 2, and at this time, good ionic conductivity of 1.8×10⁻⁴ S/cm was obtained at room temperature of 25° C.

(3) Manufacturing of Positive Electrode Using Mixture of Solid-State Polymer Electrolyte and Positive Electrode Active Material Powder

Based on LLZO:TEGDME in 1 M LiTFSI:PEGDAC, a solid-state polymer dispersion (hereinafter referred to as a solid-state electrolyte) containing a dispersant and a thermosetting agent was mixed with LiCoO₂ (D50 5 μm, Aldrich) as a positive electrode active material, and ball-milled for 24 hours. In this case, in order to secure the electrical conductivity, a powder (hereinafter referred to as positive electrode powder) obtained by mixing LCO:denka black=90:10 (wt %) was used, and toluene was added to adjust viscosity to an extent that printing is possible.

The coating solution mixed in this way was prepared as positive electrode powder:solid-state electrolyte=95:5 (wt %), which was called coating solution 1. Coating solution 2 was prepared as positive electrode powder:solid-state electrolyte=85:15 (wt %); coating solution 3 was prepared as positive electrode powder:solid-state electrolyte=75:25 (wt %); coating solution 4 was prepared as positive electrode powder:solid-state electrolyte=65:35 (wt %); and coating solution 5 was prepared as positive electrode powder:solid-state electrolyte=55:45 (wt %), and each of these five coating solutions was prepared at 20 g.

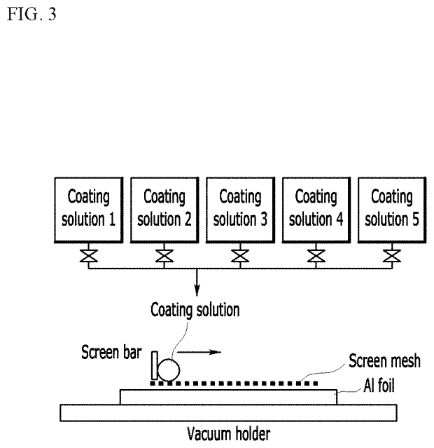

FIG. 3 illustrates a schematic view of a positive electrode plate coating method according to an embodiment of the present invention. As can be seen in FIG. 3, a composition of positive electrode powder:solid-state electrolyte=95:5 (wt %) of coating solution 1 was first printed on Al foil (20 μm) mounted on a vacuum holder, and after drying by spraying nitrogen on a surface thereof, coating solution 2 of a composition of positive electrode powder:solid-state electrolyte=85:15 (wt %) was put into a screen mesh and secondary printed in the same manner as the coating method of coating solution 1. In this case, a thickness of one-time coating was 10 μm, and all of coating solutions 3, 4, and 5 were sequentially coated in the same manner to prepare a positive electrode plate having a total thickness of 50 μm that varies stepwise.

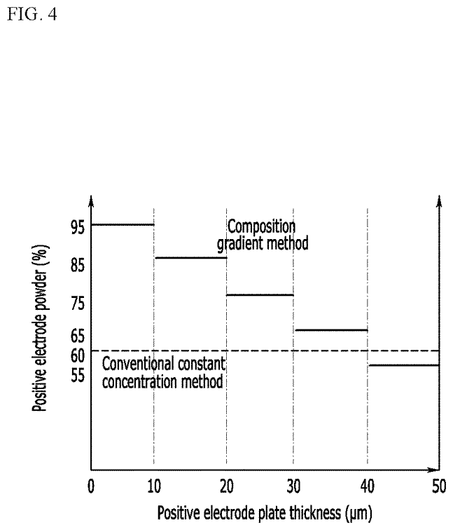

When printed in this way, in the composition of the positive electrode powder, coating solution 1 accounts for 95% in an area close to the Al foil, and as shown in FIG. 4, as the coating thickness increases, the composition of the active material has steps and gradually decreases by 10%, and finally, the composition of coating solution 5 is formed in an area close to the solid-state electrolyte.

When printed in this way, in the composition of the positive electrode powder, coating solution 1 accounts for 95% in an area close to the Al foil, and as shown in FIG. 4, as the coating thickness increases, the composition of the active material has steps and gradually decreases by 10%, and finally, the composition of coating solution 5 is formed in an area close to the solid-state electrolyte.

(4) Coating of Solid-State Polymer Electrolyte on Upper Portion of Positive Electrode

A pure solid-state polymer dispersion containing no positive electrode powder was uniformly coated on an upper portion of the positive electrode plate printed in the same manner as above by a printing method, and the coating was performed a total of 4 times so that a coating thickness is adjusted to be about 40 μm. A negative electrode plate (Honjo Metal, Japan) with about 20 μm of lithium rolled on an end surface of a Cu foil was attached to the electrode plate coated up to the solid-state electrolyte, and then thermally cured at 120° C. for 3 minutes to manufacture an all-solid-state unit cell.

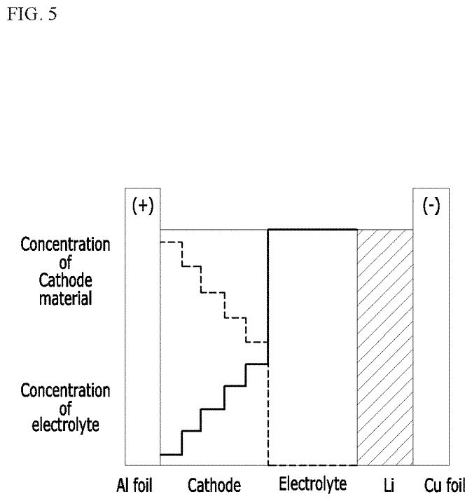

FIG. 5 illustrates a configuration view of a unit cell manufactured in the same manner as described above, wherein a cathode (positive electrode) powder coated on Al foil has a structure in which an amount thereof decreases step by step by 10% as a coating thickness thereof increases. On the contrary, as the coating thickness increases, the amount of solid-state electrolyte increases step by step by 10%.

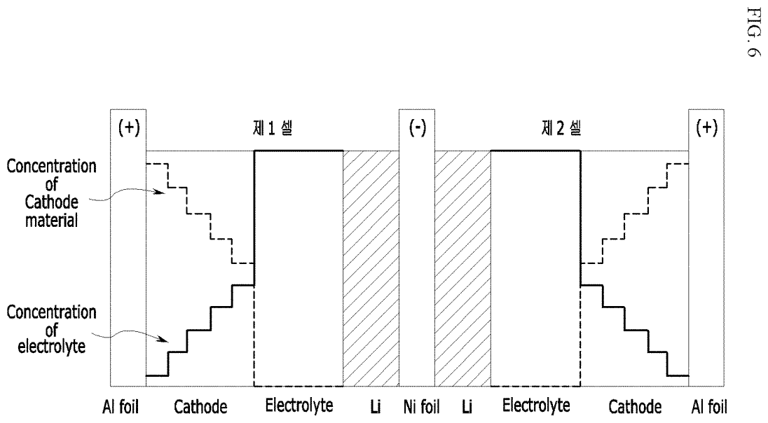

FIG. 6 illustrates a battery configuration view for manufacturing a bi-polar type of battery, which is a merit of an all-solid-state battery, using a unit cell as shown in FIG. 5, wherein in order to simultaneously use a negative positive, Ni was used as a current collector instead of the existing Cu, and after the unit cell was manufactured, it was coated in an opposite manner to the printing coating method described above.

That is, in the second cell, after coating a pure solid-state electrolyte dispersion containing no positive electrode powder on the upper portion of the lithium negative plate by the printing method, while the composition was sequentially changed in the order from coating solution 5 to coating solution 1, contrary to the printing method of FIG. 3, it was printed. Finally, Al foil was covered and thermally-cured to manufacture a bi-polar type of series cell.

### COMPARATIVE EXAMPLE 1

### Manufacturing of Uniform Composition Type of Pseudo All-Solid-State Battery

A uniform composition type of all-solid-state battery was manufactured having anode powder:solid-state electrolyte=60:40 (wt %) as a constant composition on the positive electrode current collector and the solid-state electrolyte layer. Only the composition is constant, and the coating and cell manufacturing method are the same as in Example 1.

### COMPARATIVE EXAMPLE 2

### Manufacturing of Continuous Concentration Gradient Type of Pseudo All-Solid-State Cell to which Spray Method is Applied

Positive electrode powder:solid-state electrolyte=95:5 (wt %) was called a first solution, and it was prepared in Vessel 1, and positive electrode powder:solid-state electrolyte=55:45 (wt %) was called a second solution, and it was prepared in Vessel 2, and they was used as a material for spray coating. Vessel 2 was connected to Vessel 1, and a composition in Vessel 1 was first transferred to a spray nozzle and sprayed onto the Al foil current collector, and continuously, a coating solution in Vessel 2 was transferred to Vessel 1 at a constant flow rate, thereby continuously changing the composition of Vessel 1, and thus the composition of the positive electrode powder and the solid-state electrolyte was continuously changed during the spray coating process. The positive electrode plate coated in this way has a composition in which the positive electrode and the solid-state electrolyte are continuously changed. The solid-state electrolyte layer also used a solid-state electrolyte composition of 100% to spray it on the upper portion of the positive electrode plate to manufacture a battery.

### Result

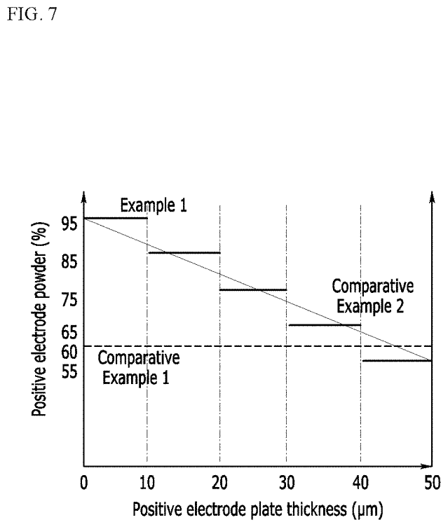

FIG. 7 illustrates a graph of concentration profiles of positive electrodes according to Example 1 of the present invention 1, Comparative Example 1, and Comparative Example 2.

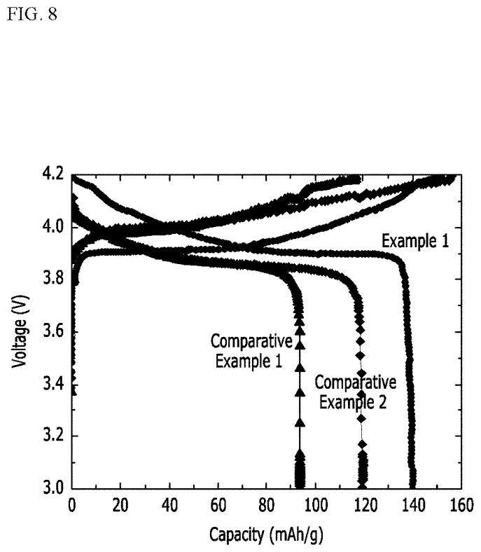

FIG. 8 illustrates charging and discharging curved line graphs according to positive electrode concentration gradients according to Example 1, Comparative Example 1, and Comparative Example 2.

FIG. 8 illustrates a charging/discharging profile per unit weight of a positive electrode active material, with respect to a conventional uniform composition electrode (Comparative Example 1) of anode powder:solid-state electrolyte=60:40 (wt %); an electrode (Comparative Example 2) in which positive electrode powder:solid-state electrolyte=95:5 (wt %) has a composition gradient with a constant slope from the current collector to the solid-state electrolyte layer, and positive electrode powder:solid-state electrolyte is 55:45 (wt %); and an electrode (Example 1) having a stepwise composition gradient from positive electrode powder:solid-state electrolyte=95:5 (wt %) until positive electrode powder:solid-state electrolyte=55:45 (wt %). A charging and discharge cut-off voltage is 4.2 V to 3 V, and a charging and discharge C-rate is 0.05 C. Since LCO is used as the positive electrode active material, the charging and discharging curve shows a phase transition plateau of typical lithium cobalt oxide. In Example 1, it can be seen that when lithium was used as a negative electrode, a phase transition of two rhombohedral structures was observed at about 3.9 V, and order/disorder, that is, hexagonal/monoclinic phase transitions, occurred at 4.06 V and 4.16 V. On the other hand, in Comparative Examples 1 and 2, it is postulated that since a main plateau appeared at about 3.85 V during discharging and a hexagonal/monoclinic peak did not appear at 4 V or higher, this ohmic drop occurred due to the resistance component of the all-solid-state battery. Comparing charging and discharging capacity thereof, Comparative Example 1 showed charging capacity of 117 mAh/g and discharging capacity of 94 mAh/g, while Comparative Example 2 showed charging capacity of 153 mAh/g and discharging capacity of 120 mAh/g. When the continuous concentration gradient was compared with the existing constant composition, the effect of increasing the capacity appeared. However, in the case of the stepwise composition gradient as in Example 1, the charging capacity was 147 mAh/g and the discharging capacity was 140 mAh/g, resulting in a very excellent capacity increase effect. For this reason, since Comparative Example 2 may increase capacity by about 30% on average compared with Comparative Example 1, although Example 1 and Comparative Example 2 should show similar discharging capacities by calculation, in practice, the increase in the discharging capacity of Example 1 by 17% or more compared with Comparative Example 2 is postulated to be due to the fact that it is difficult for the continuous composition gradient method to be substantially uniformly realized and the internal composition within the electrode plate is unevenly generated. From this charging and discharge curve, it can be seen that the stepwise composition gradient type of structure is very effective in the all-solid-state battery.

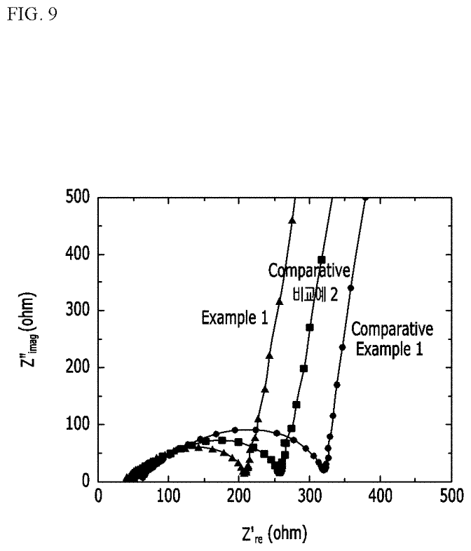

FIG. 9 is a Nyquist plot of the electrodes of Example 1 and Comparative Examples 1 and 2 measured by using an AC impedance measurement method after cell manufacturing of FIG. 8, showing low cell resistance in the concentration gradient electrode. The resistance at 1 Hz was about 320 ohm in Comparative Example 1, and decreased to about 260 ohm in Comparative Example 2, but in Example 1, it was reduced by 52 ohm to become 208 ohm. This reduction in resistance coincides with the result of the charging and discharging curve of FIG. 8.

TABLE 1

| | Initial | Initial | Initial | Initial | Raw |
|---|---|---|---|---|---|
| | charging | discharging | IR | charging and | material |
| | Volume | Volume | drop | discharging | loss rate |
| | (mAh/g) | (mAh/g) | (V) | efficiency (%) | (%) |
| Example 1 | 147 | 140 | 0.01 | 95.2 | 5 |
| Comparative | 117 | 94 | 0.13 | 80.3 | 3 |
| Example 1 | | | | | |
| Comparative | 153 | 120 | 0.09 | 78.4 | 55 |
| Example 2 | | | | | |

Table 1 shows the results of comparing the initial charging and discharging capacity, initial IR drop, efficiency, and raw material loss rate for Example 1, Comparative Example 1, and Comparative Example 2, wherein it can be seen that Example 1 has the highest initial discharging capacity, the small initial IR drop of 0.01 V, and the very excellent initial efficiency of 95.2%. In terms of raw material loss rate, in the case of Comparative Example 2, the raw material loss rate was high due to the phenomenon in which the raw material is sprayed to regions other than the electrode plate, while in the case of Example 1, it can be seen that it is economical at about 5%.

TABLE 2

Capacity retention (%)

| | | Comparative | Comparative |
|---|---|---|---|
| C-rate | Example 1 | Example 2 | Example 1 |

| | | | | |
|---|---|---|---|---|
| 0.05 | C | 100 | 100 | 100 |
| 0.1 | C | 96 | 93 | 90 |
| 0.2 | C | 90 | 82 | 79 |
| 0.5 | C | 85 | 75 | 63 |
| 1 | C | 80 | 63 | 50 |

Table 2 is a table comparing the capacity retention rate of the all-solid-state battery by C-rate, wherein it can be seen that when the capacity provided at 0.05 C is based on 100%, and the capacity retention rate of Example 1 was relatively excellent compared with that of Comparative Examples 1 and 2 in terms of C-rate increase.

From the experimental data described above, it can be seen that the concentration gradient electrode plate structure having the stepwise structure is very economical, a large area, and a commercializable process compared with the conventional constant composition or continuous composition having a slope.

In addition, in the case of the bi-polar type of all-solid-state battery as shown in FIG. 6, since the structure of Example 1 provides an OCV of 8.3 V and an initial discharge capacity of 135 mAh/g, it can be seen that the bi-polar type of structure is possible.

The present invention may be embodied in many different forms, and should not be construed as being limited to the disclosed embodiments. In addition, it will be understood by those skilled in the art that various changes in form and details may be made thereto without departing from the technical spirit and essential features of the present invention. Therefore, it is to be understood that the above-described embodiments are for illustrative purposes only, and the scope of the present invention is not limited thereto.

1. An all-solid-state battery, comprising:
a positive electrode positioned on a positive electrode current collector;
a negative electrode positioned on a negative electrode current collector; and
a solid-state electrolyte layer positioned between the positive electrode and the negative electrode,
wherein the positive electrode contains a positive electrode active material and a solid-state electrolyte, and
concentrations of the positive electrode active material and the solid-state electrolyte have a stepwise concentration gradient in which a concentration of the positive electrode active material with respect to the solid-state electrolyte decreases from a side closer to the positive electrode current collector toward a side closer to the solid-state electrolyte layer.

2. The all-solid-state battery of claim 1, wherein
in the stepwise concentration gradient,
the concentration of the positive electrode active material decreases stepwise by 5 to 15 wt % from a side closer to the positive electrode current collector toward a side closer to the solid-state electrolyte layer.

3. The all-solid-state battery of claim 1, wherein
in the stepwise concentration gradient,
the concentration of the positive electrode active material of a side closer to the positive electrode current collector is 88 to 97 wt % with respect to 100 wt % of a sum of the positive electrode active material and the solid-state electrolyte.

4. The all-solid-state battery of claim 1, wherein
in the stepwise concentration gradient,
the concentration of the positive electrode active material of a side closer to the solid-state electrolyte is 48 to 61 wt % with respect to 100 wt % of a sum of the positive electrode active material and the solid-state electrolyte.

5. The all-solid-state battery of claim 1, wherein
in the stepwise concentration gradient,
intervals between sections with the same concentration are the same.

6. The all-solid-state battery of claim 1, wherein
the positive electrode active material
is expressed as LiCoO₂, LiMn₂O₄, LiNiO₂, LiFePO₄, or LiNi_{0.5}Mn_{1.5}O₄, or by the following Chemical Formula 1:
Liₐ₁Ni_{b1}Co_{c1}Mn_{d1}M1ₑ₁M2_{f1}O_{2-f1} [Chemical Formula 1]
(in Chemical Formula 1,
0.8≤a1≤1.2, 0.3≤b1≤0.95, 0.03≤c1≤0.3, 0.001≤d1≤0.3, 0≤e1≤0.05, 0≤f1≤0.02, b1+c1+d1+e1+f1=1;
M1 is one selected from Na, Mg, Al, Si, K, Ca, Sc, Ti, V, B, Cr, Cu, Zn, Ga, Ge, Rb, Sr, Y, Zr, Nb, Mo, Tc, Ru, Rh, Pd, Ag, Cd, In, Sn, Ba, W, and a combination thereof; and
M2 is one selected from N, F, P, S, Cl, Br, I, and a combination thereof.)

7. The all-solid-state battery of claim 1, wherein
the negative electrode
includes one or more selected from a group consisting of natural graphite, artificial graphite, coke, hard carbon, tin oxide, silicon, lithium, lithium oxide, and a lithium alloy.

8. The all-solid-state battery of claim 1, wherein
the solid-state electrolyte
is a solid-state polymer electrolyte containing an oxide-based solid-state electrolyte

9. The all-solid-state battery of claim 8, wherein
the oxide-based solid-state electrolyte contains one or more selected from a group consisting of LLZO, LATP, LAGP, LLTO, LiPON, LiBON, and lithium borate.

10. The all-solid-state battery of claim 1, wherein
the all-solid-state battery is a bi-polar type of all-solid-state battery.

11. A manufacturing method of an all-solid-state battery, comprising:
coating a plurality of mixed layers including a positive electrode active material and a solid-state electrolyte on a positive electrode current collector, wherein concentrations of the positive electrode active material and the solid-state electrolyte are different from each other; and
coating a solid-state electrolyte layer on the coated plurality of mixed layers,
wherein in the coating of the plurality of mixed layers,
the plurality of mixed layers, from the mixed layer in which a concentration of the positive electrode active material is higher than that of the solid-state electrolyte, are sequentially coated on the positive electrode current collector to form a stepwise concentration gradient.

12. The manufacturing method of the all-solid-state battery of claim 11, wherein
the coating of the plurality of mixed layers
is printing and coating a mixed solution obtained by mixing a positive electrode active material and a solid-state electrolyte dispersion; and
the coating of the solid-state electrolyte layer on the coated plurality of mixed layers
is printing and coating the solid-state electrolyte dispersion.

13. The manufacturing method of the all-solid-state battery of claim 11, wherein
the coating of the plurality of mixed layers and the coating of the solid-state electrolyte layer on the coated plurality of mixed layers
use a screen printing method.

14. The manufacturing method of the all-solid-state battery of claim 11, wherein
in the coating of the plurality of mixed layers,
in the stepwise concentration gradient, the concentration of the positive electrode active material is constantly varied in steps by 5 to 15 wt %.

15. The manufacturing method of the all-solid-state battery of claim 12, wherein
the solid-state electrolyte dispersion includes an electrolyte solution, an oxide-based solid-state electrolyte powder, and a polymer matrix.

16. The manufacturing method of the all-solid-state battery of claim 15, wherein
the oxide-based solid-state electrolyte powder contains one or more selected from a group consisting of LLZO, LATP, LAGP, LLTO, LiPON, LiBON, and lithium borate.
